(19) United States
(12) Patent Application Publication
(10) Pub. No.: US 2025/0376182 A1
(43) Pub. Date: Dec. 11, 2025

(54) Proactive Computerized Vehicle Control Using Commands Composed of Letters, Numerals, Arithmetic Operators, and Meta-Commands

(71) Applicant: John Clifton Medcalf, Valley Center, CA (US)

(72) Inventor: John Clifton Medcalf, Valley Center, CA (US)

(21) Appl. No.: 18/737,943

(22) Filed: Jun. 7, 2024

(51) Int. Cl. B60W 50/10; B60K 35/26; B60W 50/14; G06F 3/01

(52) U.S. Cl. CPC B60W 50/10; B60K 35/26; G06F 3/017; B60K 2360/146; B60W 2050/146

(57) ABSTRACT

A computer mediated method for effecting proactive control of computer-controlled processes and/or devices related to a vehicle. Proactive control is enabled by computer recognition of a proactive user who is drawing (writing), signing, keyboarding, or voicing characters (letters, numbers, punctuation) and meta commands (such as DONE, NEXT, CANCEL) and transmitting an encoding of the characters and meta commands to the computer program that is empowered to control the vehicle. Drawn characters may be drawn on a touch sensitive device, on a surface viewable by a camera, or in three-dimensional space unrelated to a surface. All mechanisms for delivering encoded characters and meta commands to the computer directly controlling the vehicle are subsumed by this patent. Feedback is provided by the computer directly controlling the vehicle via a display and/or speech in order to close the loop on interpretation of the character and meta commands.

### CROSS REFERENCE TO RELATED APPLICATIONS

This present application claims priority from provisional patent application 63/506,645.

“This is a continuation-in-part of application No. 63/506,645, filed with title “Universal Method for Proactive Computerized Vehicle Control” and naming John Clifton Medcalf as inventor, the entire content of which is hereby incorporated herein by reference.

### FEDERALLY SPONSORED RESEARCH

No federally sponsored research was involved.

### SEQUENCE LISTING OR PROGRAM

None.

### SPECIFICATION

### Background of the Invention

Touch screen displays with on-screen controls have been shown to distract drivers to the point of those distractions being designated as a cause of greater than ten percent of accidents (National Highway Traffic Safety Administration study).

Touch screen displays with on-screen controls will proliferate:
1. Automobile manufacturers are increasingly using touch screen controls to save money by eliminating the manufacturing and integration costs of additional buttons and levers and dials.
2. In order to increase profits, automobile manufacturers are using touch screen controls to extend the options for vehicle control and for in vehicle environment control and for in vehicle infotainment systems to compete in the realm of digitally controllable features and to make higher priced vehicles more desirable and to generate recurring revenue.

Drivers are having safety concerns with current touch screen implementations:
1. Touchscreen controls are known to be unreliable in executing commands on the first try, especially in moving vehicles.
2. Attempting to execute a function offered by a touch screen target such as but not limited to a button or slider or icon or link or menu choice often results in the touch being interpreted such that screen contents shift instead of the function associated with a touch screen target executing.
3. Touch screen displays may be difficult to read. The reasons are numerous including text and/or action targets too small, insufficient contrast for text and/or action targets, incident light from inside or outside of the vehicle reflecting into a driver's eyes and obscuring text and/or action targets, driver vision limitations, driver using glasses or contact lenses prescribed for distance vision making text and/or action targets unrecognizable, alerts disappearing too quickly.

Automobile manufacturers are suggesting that speech recognition allows drivers to avoid having to use the vehicle touch screen controls.

The hypothetical value of reliable speech recognition is unquestioned. However, it appears to be permanently out of reach.
1. Speech recognition is almost universally known to be unreliable in executing commands for many people due to voice characteristics and because of environments with ambient sounds.
2. Vocal controls are notably unreliable in executing commands spoken by a speaker with an accent or a speech pattern significantly different from those used to train the speech recognition software.

The mechanisms for vehicle control including immediate control, the setting of control values, and the control of what will be displayed and when it will be displayed are customized by each manufacturer. This makes vehicles used on a temporary basis such as rental vehicles more challenging to drive safely.

Execution of commands on the first expression of the command is essential in some situations for some commands.

Execution of commands on the first expression of the command is always desirable to avoid frustration. Frustration can create and/or add to mental distraction in the driving environment.

There are currently no command interfaces for use by a driver while driving where a touch screen display or speech recognition provides reliable command recognition while vehicle is moving.

As vehicles regularly surface more digital services such as entertainment and connection to messaging and calendars and digitally controlled functions such as windshield wipers and steering and shock absorber tightness, there will be more and more times a driver will want to interact with a vehicle's digital controls while the vehicle is moving.

Since interacting with a touch screen is distracting to a driver, it is dangerous. It is dangerous not only to the occupants of a vehicle but also to any persons and or property that a moving vehicle might hit or whose driver it might distract by erratic behavior of the originally distracted driver.

Both popular and academic literature recognize the distractive nature of touch screen displays.

No prior art that offers a clean, simple, easily understood proactive method for reducing distraction to a minimum has been discovered in writings or at car shows as recently as December 2022.

Modern vehicle control is majority digital. This means that the mechanism for a driver effecting a change in a vehicle's movement or its environment, or for querying a vehicle's status, are communicated from the affordance the driver engages with (button, knob, slider, toggle, touchscreen, microphone, or combination) to the object being controlled via a digital communications channel such as but not limited to wire or WIFI or Bluetooth.

Controls such as turn signals and entertainment system volume adjustment are typically implemented with a physical (often called analog) affordance with one or several degrees of freedom which, when moved in an afforded direction, command the desired result such as flashing turn signal lights and changing the entertainment system audio volume. Such controls can often be employed without looking away from the road and outside environs and with confidence the commanded action(s) will be effected.

Many physical affordances in vehicles are poorly visually accessible. This is because, from many manufacturers, many buttons and knobs look alike except for a dimly lit icon or a label with a small font on the affordance or proximate to the affordance.

In the future, the lower engineering and manufacturing costs of presenting controls via a touch screen display rather than through bespoke buttons, dials, etc. will drive vehicle manufacturing companies to move more controls to a touch screen display.

In the future, more vehicle functions with more driver selectable options will be made available to the driver as a means to compete in the marketplace. We see examples today in handling (suspension, steering, acceleration), comfort (seat position, lumbar support), cameras (backup, blind spot, forward looking) and media control (type, source (local or streaming)) among categories of functionality having increasing numbers of options available.

More fine grain control of adjustable attributes of a vehicle will be another offering from vehicle manufacturers. Management of control parameters can be engineered and implemented at small cost using a touchscreen display.

Examples of tuning the driver's environment include such things as:

The number of times the seat belt unfastened bell dings and under what circumstances such as starting the vehicle or only upon first press on the accelerator.

Whether to have windshield wipers restart when the car is restarted and the car had been stopped with the windshield wipers engaged.

Whether to restart the car with the same climate settings (front seat air flow and temperature, rear seat air flow and temperature, seat(s) heated, steering wheel heated or whether to start up with some of these settings either reset to a default or based on the sensed environment and passenger load.

Camera settings for size and direction of their fields of view, when to show the camera views on screen, whether to blur objects at a distance and starting at what distance in order to make nearby objects stand out.

This increase of control options will likely become a dominant aspect of competition in the motor vehicle market. The experience of being in control of the driving environment may become the most important factor in selling.

Affordances that are not instantly locatable on a display screen or are not providing instantly cognizable feedback are the majority of what is currently offered for control within vehicles. A are distracting drivers from recognizing risks in the vicinity of the vehicle and therefore they are making operating a vehicle riskier. This risk extends to occupants of the vehicle and people, pets, and property outside the vehicle that the vehicle might impact.

The same is true of all physical controls that are not uniquely recognizable by touch or accessed by reliable muscle memory trained by frequent use.

Typical vehicle touch screen controls, where a display is integrated to provide feedback, draw visual focus away from the outside environs. This is because the position of the desired control must be visually located and the arm/hand/finger must be guided to the presumed active area of the affordance—the target.

To prevent distress, the targeted control must react appropriately. Many touch screens quickly decide that a touch was meant to indicate something other than execute the desired target's task and instead initiate scrolling or do nothing or initiate a process associated with a different task. Some do nothing but display a jiggle or a change in appearance (brightness and color) which causes distraction through confusion. Confusion prolongs and exacerbates the distraction.

A preponderance of vehicles today use digital controls based on a touch screen (combination display screen and touch sensitive surface coincident with the display screen surface) or a display screen with control mechanisms physically disjoint from the display surface. These might be touch pads or dials or joysticks or buttons or some combination of these affordances.

Touchscreen interfaces where the surface of the screen is used to communicate the user's intent frequently fail to accept a user's intent until the user makes several attempts to specify their desired choice. The reasons for this include a touch missing the target and the software not identifying if the touch was meant to select a target or to initiate a scroll or a shift of the display contents. Unintended scrolling can require several additional interactions with the touch screen to complete an intended action.

These problems are exacerbated in a moving vehicle which add the likelihood of the software deciding that a target other than the user's choice should respond to the touch. This can lead to further distraction if corrective action must follow the unintended response to the touch.

Voice commands can provide some users a preferable control mechanism for some intended actions. Speech recognition does not work for many people because of accents, dialects, speech impediments, pitch, speed of speaking, respiratory infection, face masks, audible media, in vehicle conversations, road noise, vehicle mechanical noise and possible other audible interferences.

Vehicle digital controls lack standards for a majority of said vehicle's functions. Rental vehicles will present an ever-increasing likelihood that drivers will be learning their rental vehicle's controls over a period of days as the number of options increases. This will hold true for vehicles made available to a driver for any reason. Drivers of rental vehicles also risk confusing a rented vehicle's controls with those of a vehicle they drive regularly or that they have previously driven.

### DESCRIPTION

The invention being specified is a previously unused method for commanding responses from a computerized vehicle control system which takes in command codes from a commanding computer software.

The software that recognizes driver actions and interprets them as characters and meta commands and encodes them and exposes them to the commanded computer software interface Is the commanding computer software.

The software that accepts the encoded characters and meta commands is the commanded computer software. No attribute of the commanded computer software is claimed by this patent other than that it be able to take in character and meta command codes exposed by the commanding computer software.

A computerized vehicle control system is the hardware and software that accepts user who is usually but not necessarily the driver and manages vehicle actions and feedback and setting of parameters.

The inventive concept common to all embodiments is a method for commanding actions from a computerized vehicle control system utilizing the simplest universally available and reliable command language-the characters used by everyone from kindergarten age on up (five years old) to spell and to do arithmetic.

This is the Writrol (Write+Control) method for commanding behavior from a computerized vehicle control system.

An embodiment category, which may be the most flexible and reliable, is the use of a software executing in a computer, possibly shared with other software, to classify driver finger gestures as characters and meta commands (such as CANCEL or REPEAT) and deliver those to a computerized vehicle control system for interpretation and initiating actions.

This patent application will claim any mechanism that delivers characters to a computerized vehicle control system for the purpose of commanding a response from said computerized vehicle control system as an embodiment of the inventive concept described in this patent application.

The Writrol mechanism depends on computer code to recognize gestures and/or spoken sounds and/or keyboard inputs specifying characters and meta commands based on inputs from one among a plurality of sensing devices. These at least include a touch pad, a touch screen on a smart phone or tablet, a plurality of cameras, a plurality of microphones, and a one-handed keyboard.

Future technology might allow brain wave selection of said characters and meta commands and, as such, would embody the Writrol method.

Everyone qualified to drive lives in a world of characters. In most jurisdictions, drivers must be able to pass a written drivers' license test.

Traditionally, American kindergarteners are taught to draw the block capital letters and the digits.

Hellen Keller is reputed to have first understood the concept of words as the word “WATER” was drawn on her palm.

Letters and digits can be reliably drawn by anyone with the bodily control demanded of a driver.

Said persons, with such bodily control, can reliably draw the letters and digits without looking.

Said persons can draw the letters on any surface or in the air distant from a surface in a manner that their strokes can be discerned by various computer peripherals including touch sensitive surfaces and cameras.

Hand drawn characters have been used for data input since at least the 1990s on the Palm Pilot using the Graffiti alphabet. Hand drawn characters were not used as commands. Characters entered into a Palm Pilot were not used to control an independent device.

Pluralities of strokes being interpreted as characters by computer algorithms is current technology available commercially to those who would employ the Writrol method.

The unique use of characters exposed in this patent is for reliable proactive control where control previously depended on either choosing options from a touch screen menu (reactive) or spoken commands (proactive but unreliable).

Characters are ingrained into most people's brains to the extent that most people can draw them with confidence without looking.

Characters can be vocalized by most people although there are several pairs of characters that sound too much alike to trust they would be distinguished without using the military alphabet (alpha, bravo, charlie, delta . . . ).

Drawing command characters is the embodiment that affords the largest number of drivers immediate access to the benefits of using characters as commands.

The invention comprises a commanding computer software to recognize the user's characters and encode them and make them available to a commanded computer software. These two softwares may run on the same or different computers. These two softwares are the anchors letting us define where the Writrol method begins and ends.

All embodiments have a boundary at the interface between the commanding computer software and the commanded computer software where the encoded characters are passed from the former to the latter. The interface may be in memory or via wired or wireless communication channels.

The commanded computer software is part of the overall vehicle control mechanism and, as such, its characteristics will influence the utility of the Writrol method for various manufacturers. The commanded computer software is not claimed in this patent application. The commanded computer software will be developed by those entities wishing and authorized to use the Writrol method.

One embodiment of the invention is a commanding computer interfaced with a dedicated peripheral with a touch detecting surface (touch pad) easily accessed in its totality by at least one of a user's fingers where said surface is discriminating in two dimensions as to the position that is being touched at any time a finger is touching the surface. Said commanding computer executes a software means for interpreting patterns of touching as being characters or gestures specifying meta commands.

Said touchpad is optimally located so as to be reached and engaged comfortably with whichever driver's hand is most comfortable drawing characters and meta commands. This may be atop the center console where the center console provides an armrest and the touchpad is located on the axis of the center console to fall under the driver's hand when the driver's arm is comfortably rested.

Alternatively, this may be located on the axis of and fore of the driver's hand when resting on the driver's door armrest.

Said touchpad may be a permanent fixture of the vehicle, attachable to the center console or securely rested on the center console in a position to be comfortably accessed by the driver's drawing finger. Said touchpad may be a permanent fixture of the driver's door mounted armrest. Said touchpad might also be held in the driver's lap or worn by the driver on a lanyard or protruding from a shirt pocket.

It is desirable that the commanded computer and/or devices which it controls will provide feedback to the person issuing commands using any available communication interface including but not limited to display screens, display lights, display gauges, audio whether emitting language or non-language sounds, haptic, as well as the feedback implicit in experiencing commands being executed or attempted by the commanded system. Feedback mechanisms and protocols are not part of the invention.

A second embodiment of this invention would be a character detecting, encoding, and transmitting commanding computer software run on a smart phone or tablet device (commanding computer) which device's touch pad would be positioned on the central console of a vehicle central of the driver's seat or on the driver's door armrest if said device is secured to said armrest. A smart device with a touch sensitive surface might also be placed on a driver's lap or hung around a driver's neck resting on their chest. The driver would extend a finger and draw a plurality of characters when they wished to execute a command.

A third embodiment would substitute a non-sensory surface for the touch sensitive surface. This surface and finger movements above said surface would be monitored by a camera or other finger position sensing device that does not require touch sensing. This embodiment would require that the commanding computer software recognize the same strokes that it would recognize coming from a touch pad or touch screen.

Said non-sensory surface could be a portion of the center console or of an armrest. Said non-sensory surface could be a driver's leg, a driver's clothing in the leg area, or an object that could be set on a driver's leg or lap.

The optional locations of surfaces that could be viewed by cameras to successfully interpret drawn characters would depend on the fields of vision of the plurality of cameras.

A fourth embodiment would interpret a sign language used by persons who are deaf and communicate primarily through a sign language such as ASL, American Sign Language. Software to recognize ASL signs is commercially available.

A fifth embodiment would be specifying characters and meta commands using implantable or surface connected brain-computer interfaces. This may not happen during the life of a patent. It does speak to the theme of the invention.

Additional embodiments will be recognized as they allow the proactive selection of characters and meta commands without looking. Remember that the invention is first and foremost about reliably eliminating the cognitive load and distraction of locating and selecting commands as compared with specifying said commands by finger drawn or selected commands or spoken commands.

As an example, using character drawing, the driver might draw the characters “WWF” or “WW4” to activate the windshield wipers at Fast speed or speed “4” as named in Tesla Model 3 controls.

As another example, the driver might draw the characters “OT” or “OG” instead of searching for the menu options to open the trunk or the glove compartment.

The commanded computer software and vehicle would respond to the controls as appropriate to the intended tasks. The commanded computer software would optionally provide feedback and where appropriate, remind the driver of options via appropriate communication devices such as a plurality of display screens and/or a plurality of speakers.

When instantiating the invention, transmission of commands from the commanding computer software embodying the invention to the commanded computer software could use any appropriate channel such as an in memory API, Bluetooth, LEDs, infrared, ultrasound, audible sounds, radio, or means still to be discovered or invented.

Now that we have described the invention in action, let's look at the ecosystem that would be built around the invention.

First, of course, is the revision of the vehicle's control computer software to receive commands, interpret them, and provide feedback. Such updates by the vehicle manufacturers are essential to make the combined systems (commanding computer and software of the plurality of devices embodying the invention and the commanded computer and software of the vehicle manufacturer) most useful to the driver.

Second would be the vehicle manufacturer's choices of commanding computer and software for integration with the commanded computer and software. Vehicle manufacturers would likely accept smart phones and tablets as commanding computer software input devices for commands. Vehicle manufacturers might look to standardize on best of class computerized touchpad only devices to offer as an OEM feature or might find their vehicles were best served by a bespoke computerized touchpad. Vehicle manufacturers can choose to run the commanding computer software in their commanded computer using touchpad input or camera input of the character and meta command drawing actions. This implementation still isolates and circumscribes the pure invention but in software rather than in a combination of hardware and software.

Following on, in no particular order, are various avenues to personalize each driver's interactions with the invention.

These avenues would include the capacity for the driver to train the character recognition capabilities of a computer software to recognize among other possibilities, how said driver draws and or poses letters and meta commands or how they speak characters and meta commands.

Another avenue for personalization would be the capacity to take this training offline from the vehicle thus allowing the driver to train the software anywhere they could use their smart phone or tablet or could set up a camera and training software on a PC which could be Intel or Mac or Linux or Android or on the Web or on devices not yet known.

Another avenue for personalization would be the capacity to override a vehicle manufacturer's standard command set. This might be desirable, among other reasons, for a driver to make the command set more memorable or to shorten some commands that might be most used.

An outgrowth of being able to personalize specific commands would be a likely users' group forming to suggest standards to both manufacturers and drivers.

Standards would offer an additional benefit to people renting vehicles if they could use their personalized command language in rental vehicles or borrowed vehicles.

Another standard to be pursued would allow drivers to take their personalized command language with them vehicles made temporarily available by family or friends, likely on their smart phone, with only non-standard features requiring a discovery mechanism.

Another complementary method of the commanded computer software would feed back on the vehicle's display in text as large as could accommodate a menu without scrolling, the options that the commanded computer software recognized could be associated with the plurality of characters drawn so far. This could be used to train a driver by showing a command character sequence adjacent to each menu item that would take the commanded computer software directly to the desired action.

When said menu was short the menu item could display large thus making them easy to grasp in a second or less. At that point, the driver could opt to touch the desired menu item on the display screen rather than add a character or two to the then current command sequence.

While in a Writrol equipped vehicle, auditory feedback when a command was partially entered and then a menu choice selected would assist in learning the command sequence to effect the action just selected.

Try drawing characters right now, with your eyes closed, on your desk or the arm of your couch. Think how nice it might be to have those characters give you access to your office or home climate control. Think how nice they might be for TV control. Think if they could call your kids or call a friend or bring up a shopping site on your TV or iPad and immediately search for what you're naming.

Especially notice how easy it is to draw characters.

Drawing characters to do any of the above feels easy. Think how reassuring it will be to know you and your loved ones can use this when driving.

Just Do It—JDI. Those are some good characters to start with.

Although not claimed as a part of this patent, two themes are required to enable this invention to be most beneficial. I define most beneficial as providing all necessary and useful functionality in a minimally distracting fashion.
One is legibility for anyone whose vision (including glasses or contact lenses if required by their motor vehicle authority) qualifies them to drive and
The other is that bottom level screens (menu end points), those that provide for actual adjustments, are single purpose screens utilizing all available space to allow targets to be as large as possible and thus the least demanding on the driver's physical dexterity.
1. The screens displayed in response to the transmitted characters and meta commands should be either:
   a. A short menu using a big enough font and with enough contrast to read at a glance, even with minimal legal visual acuity required to obtain a driver's license. Menu choices should also be large enough for touch selection in a bouncing vehicle.
   b. Single purpose screens such as for driver's climate control or playlist or radio station selection or lumbar support setting. Controls for any function should be large enough to utilize in a bouncing vehicle.

All screens shown in response to character or meta commands should show the character(s) and meta command(s) in a standard place on the screen with sufficient boldness to foster sub-second recognition.

All screen only interactions (prior to effecting a physical change) should lead to sub second responses by the feedback mechanism(s).

01—A method for a human driver to proactively command a vehicle's computerized control system to execute functions of said vehicle, said method comprising:
(a) Interpreting said driver's finger movements and/or said driver's posing of fingers as used by sign languages for the deaf and/or said driver's vocalizations, and/or said driver's pressing a plurality of keys, or methods yet to be enumerated, or methods yet to be discovered, and
(b) Associating a character or a meta command encoding with said driver's finger movements and/or said driver's posing of fingers as used by sign languages for the deaf and/or said driver's vocalizations, and/or said driver's pressing a plurality of keys, or methods yet to be enumerated, or methods yet to be discovered, and
(c) Exposing and/or transmitting that code to a commanded computer software among whose functions are that of controlling said vehicle and driving a plurality of displays and/or a plurality of speakers to provide feedback to said driver, and
(d) Whereby said driver's desired responses by said vehicle are commanded.
